(19) United States
(12) Patent Application Publication
(10) Pub. No.: US 2003/0182245 A1
(43) Pub. Date: Sep. 25, 2003

(54) Internet commerce system and the method

(76) Inventor: Dong-Seok Seo, Seoul (KR)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/363,883

(22) PCT Filed: Sep. 10, 2001
(86) PCT No.: PCT/KR01/01529

(30) Foreign Application Priority Data
Sep. 9, 2000 (KR) 2000/53839
Jul. 16, 2001 (KR) 2001/42678

(51) Int. Cl. G06F 17/60

(52) U.S. Cl. 705/75

(57) ABSTRACT

The purpose of the invention is to provide an Internet commerce system and a method, where a personal information such as a settlement ned not be provided to the seller, where the money is settled to the shopping mall after the delivery is confirmed, thereby protecting the users, and where denial of the purchase of the user cannot happen, thereby protecting the seller. In order to accomplish the purpose, the invention provides an Internet commerce system including (1) a user's terminal which can provide shopping information to the user and can perform an on-line purchase and can perform a date communication through the Internet; (2) a shopping mall server formed on the on-line in order to provide various product data and to sell the products; (3) a settlement server formed on the on-line in order to provide a credit information and to perform settlement of the deal between the user and the shopping mall; (4) a service server communicating with the user's terminal, the shopping mall server and the settlement server, receiving the deal approval information and sending it to the user's terminal and the shopping mall server, letting the shopping mall have the settlement money when receiving a deal ending signal from the terminal. This system is buyer's initiated settlement system and can enhance safety of the deal.

### TECHNICAL FIELD OF THE INVENTION

The present invention relates to electronic commerce occurring on the Internet or World Wide Web. More particularly it relates to a system and method for an Internet commerce which offer the payment system concentrated on secure transaction for buyers or consumers.

### CONVENTIONAL ART OF THE INVENTION

In recent years, the electronic commerce market increases dramatically. However, the electronic commerce is not used widely because of a high commission, a low reliability of shopping mall, an accidental spreading of personal information, a high cost of product distribution, a non-standard of settlement system, loopholes in law, and/or tax problems. Further, the consumers hold grievances against the merchandisers or producers when the goods are delivered to wrong address or not at all or when there are some problems in quality of the goods. Therefore, it is required to protect consumers' rights, and the consumer-oriented preparations are necessary in the electronic commerce.

When the consumers buy the goods in the electronic commerce marketplaces through an Internet or World Wide Web, they pay in cash, with a credit card or in electronic cash. If the consumers pay in cash in advance when they buy something in the electronic commerce, they will have some problems in a viewpoint of consumerism whenever they want to return the goods or cancel the transactions. Namely, the buyers should make efforts and it takes a lot of time to get a refund. Further, when the consumers use the electronic cash such as a prepaid IC card in the electronic commerce market, they also have to pay in advance to get this prepaid IC card. Therefore, the electronic cash is not actually put into practical use and there are also some problems when the consumers return the goods they bought and cancel the transactions.

Accordingly, a credit card is widely used in the electronic commerce market. However, since the buyers send their credit card information to the shopping mall, there are still some problems, such as a leakage of credit card information and an incorrect amount demanded. Thus, the consumers hesitate to use the credit card. Further, when the products are not delivered or inadequately delivered or when the products have some defects, the buyers waste time on returning the products and on getting the refunds. Additionally, some credit card users deny the transactions even though they really used the credit card and got the products. In spite of these problems, there is no good solution to these problems.

On the ground of above-mentioned problems, it is required that a new settlement or payment system insuring secure transaction be introduced in the electronic commerce market. Therefore, a new electronic payment system, which ensures a payment by way of properly organizing a transaction approval method and a payment method when the buyers receive the products they wanted from the shopping mall, is required. Additionally, the new electronic payment system, which refuses payment when the buyers receive the improper products or do not receive the products or when the products have the defects, is required so as to promote the electronic commerce.

### DETAILED DESCRIPTION OF INVENTION

Accordingly, the present invention is directed to an electronic commerce that substantially obviates one or more of the problems due to limitations and disadvantages of the related art.

An object of the present invention is to provide an electronic commerce system and method thereof, which prevents an unauthorized use (e.g., hacking, snooping, etc.) or a demand of incorrect amount from the shopping mall and refusal of payment by the buyer.

Another object of the present invention is to provide an efficient method, which decreases the cost caused by returning the products when the buyers find the defect in the products.

Another object of the present invention is to provide electronic commerce system and method thereof, which decrease inputting information and embody the automatic solution in information verification and communicate information automatically.

Another object of the present invention is to provide an electronic commerce system that solves the refund problem prior to receiving the products.

Additional features and advantages of the invention will be set forth in the description which follows and in part will be apparent from the description, or may be learned by practice of the invention. The objectives and other advantages of the invention will be realized and attained by the structure particularly pointed out in the written description and claims hereof as well as the appended drawings.

In order to achieve the above object, an embodiment in accordance with the principles of the present invention provides a system for an electronic commerce includes: (1) a buyer's terminal that is used for purchasing goods through on-line service and that provides data communication and an Internet communication; (2) a shopping mall server providing various product information to the buyer's terminal so as to sell the goods on the Internet; (3) a payment server providing buyer's credit information and financial information for on-line electronic commerce, the payment server approving the transaction and conducting the settlement; and (4) a transaction service server connected to the buyer's terminal, the shopping mall server and the payment server, the transaction service server requesting the payment server to approve the transaction after receiving purchasing information from the buyer's terminal, sending the transaction approval information to the shopping mall server and buyer after receiving the transaction approval information from the payment server, and paying for the products to the shopping mall server so as to acting as a go-between for the electronic commerce system when the delivery and the transaction are complete and when the transaction service server receives transaction completion information from the buyer's terminal.

The above-mentioned buyer's terminal includes a product selecting section helping the buyer to select the products that the buyer wants; a purchase information storage section storing data of the buyer's purchase information; a payment selecting section presenting the buyer with a selection of the forms of payment, thereby doing the process of the transaction in accordance with the selected payment method; a purchase completion confirming section sending the transaction completion information when the delivery is complete; and a communication section providing data communications among data communication equipments that are connected through the on-line.

The shopping mall server includes a product information transmitting section 210 sending product information to the buyer's server; a payment checking section validating the buyer's ability of paying for the ordered product; and a product transmitting section sending the ordered products to the buyer.

The transaction service server includes a payment and purchase information storage section handling the payment and purchase information about the ordered product from the buyer's terminal; a transaction approval inquiry section requesting the payment server to approve the transaction in accordance with the purchasing proposal from the buyer's terminal; a transaction approval information storage section storing the transaction approval information data transmitted from the payment server; a temporary bank: account momentarily keeping the money for the ordered product, which is transmitted from the payment server; a product transmission information storage section storing the product transmission information transmitted from the shopping mall server; and a payment settling section conducting the settlement after the transaction is complete.

Furthermore, the transaction service server provides the shopping mall sever with the payment information including bank account, password and credit card number.

### BRIEF EXPLANATION OF FIGS

The accompanying drawings, which are included to provide a further understanding of the invention and are incorporated in and constitute a part of this specification, illustrate an embodiment of the present invention and together with the description serve to explain the principles of that invention.

In the drawings:

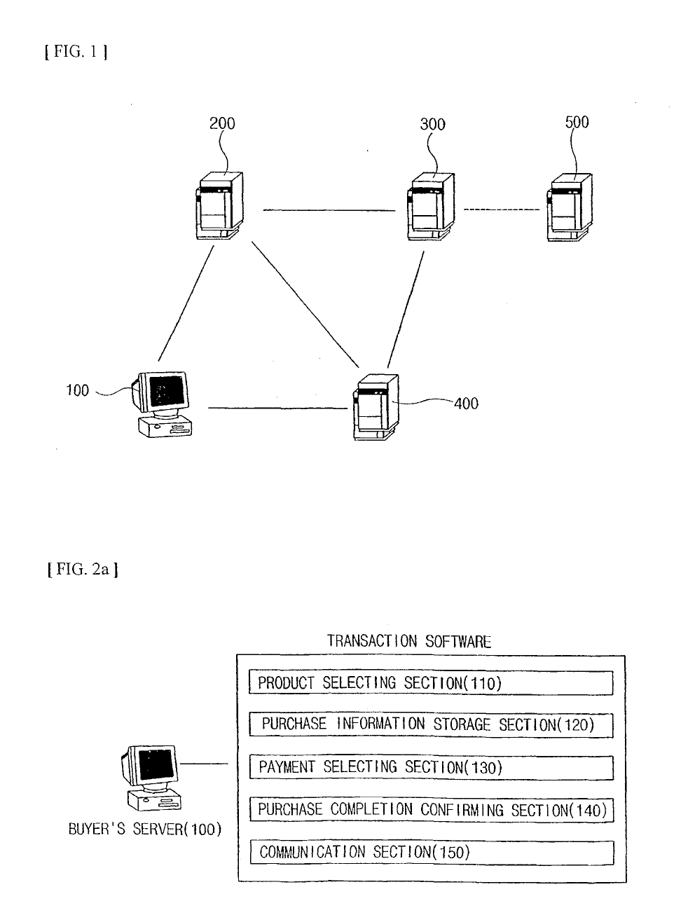

FIG. 1 is a schematic representation of an electronic commerce system according to a first embodiment of the present invention;

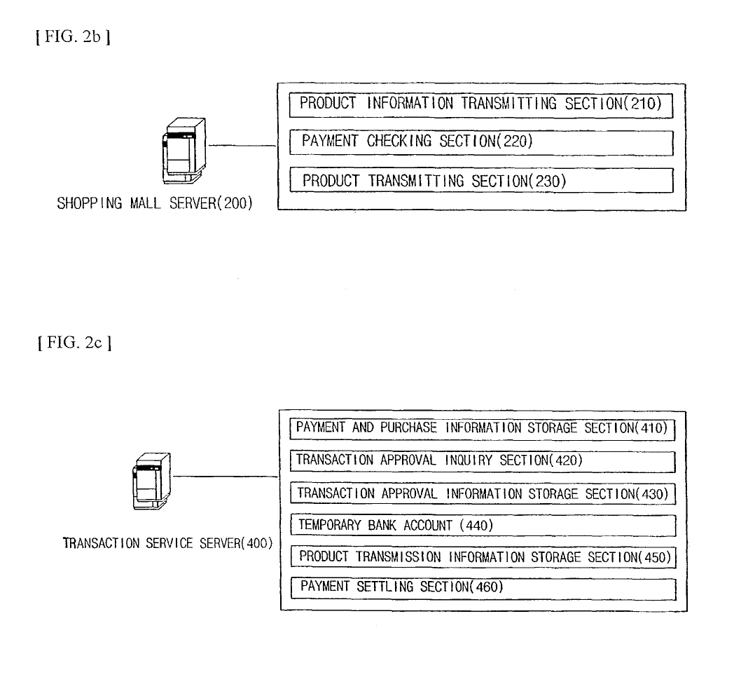

FIGS. 2a, 2b and 2c are block diagrams showing functional configurations of buyer's terminal, shopping mall server and transaction service server, respectively;

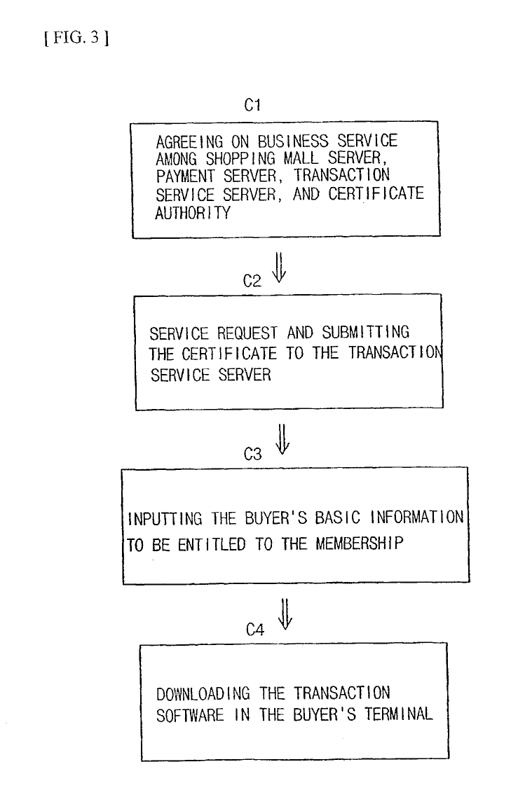

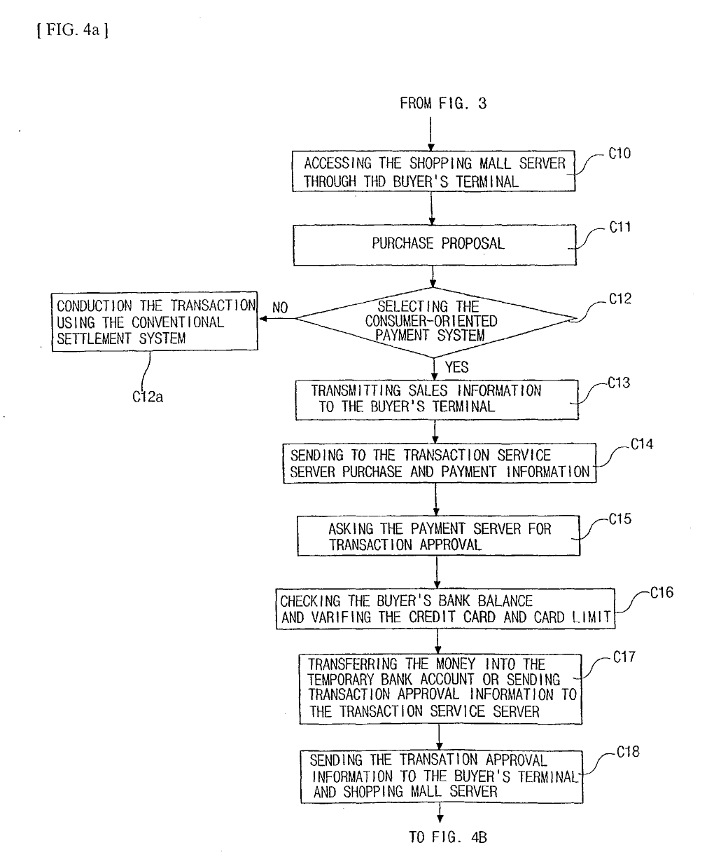

FIG. 3 is a flowchart depicting an essential prerequisite to perform the first embodiment of the present invention;

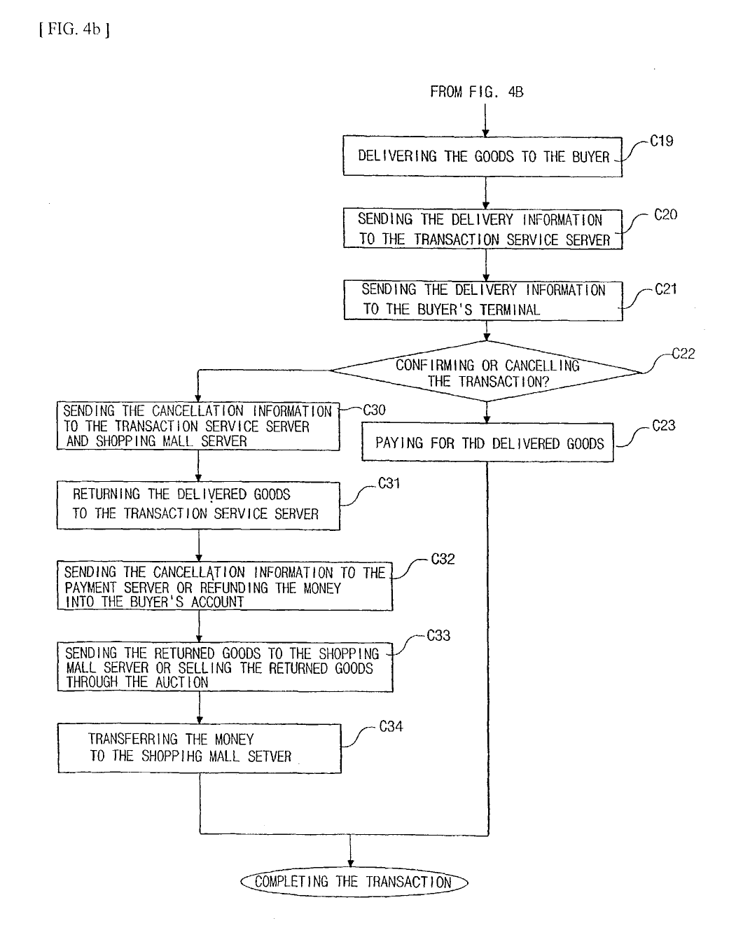

FIGS. 4a and 4b are flowcharts depicting the process of the electronic commerce system according to the present invention;

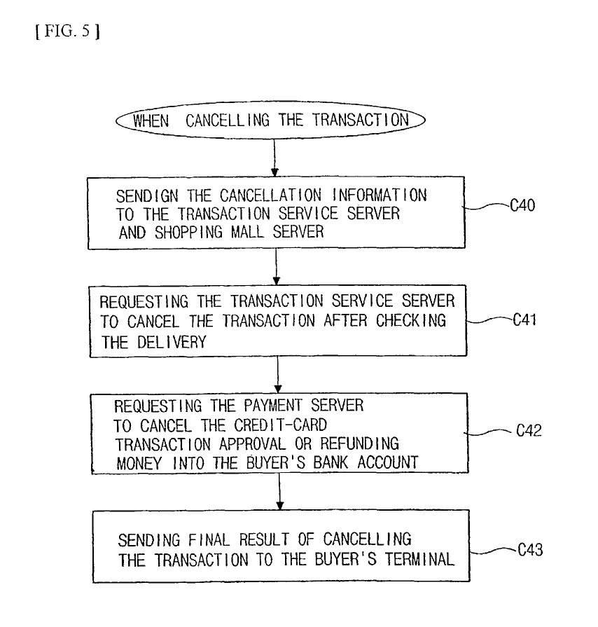

FIG. 5 is a flowchart depicting the steps of FIG. 1 performed when the buyers cancel the transactions due to the non-delivery of the ordered products; and

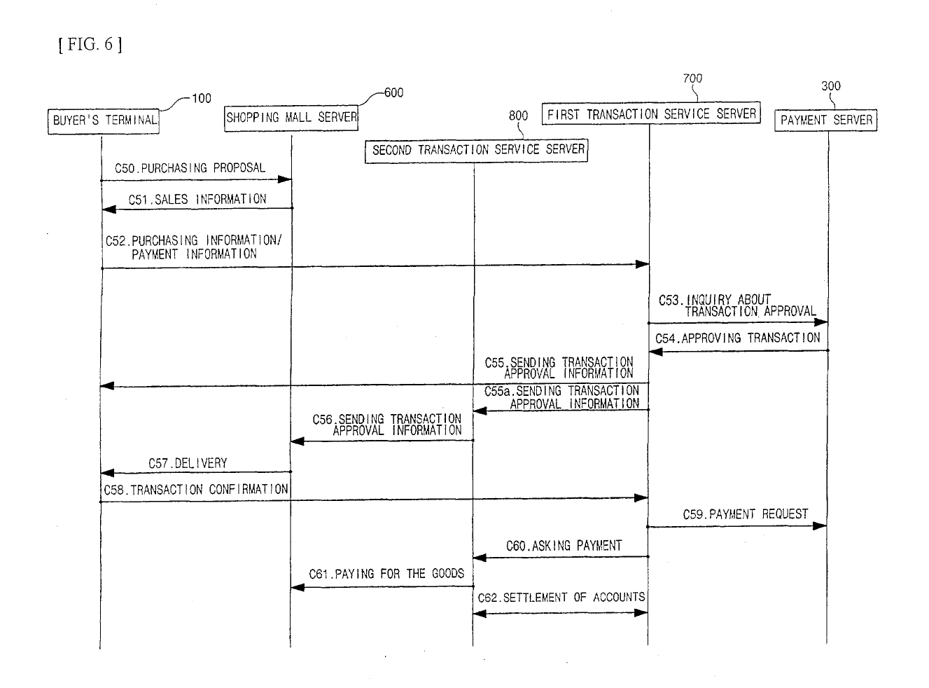

FIG. 6 is a flowchart depicting a second embodiment of the present invention performed when the transaction service server and the shopping mall server are plural.

*Brief explanation of reference numerals for main portions in the drawing*

| | |
|---|---|
| 100: Buyer's terminal | 200: Shopping mall server |
| 300: Payment server | 400: Transaction service server |
| 500: Certificate authority | |

### THE BEST MODE FOR INVENTION

Reference will now be made in detail to illustrated embodiments of the present invention, an example of which is shown in the accompanying drawings. Wherever possible, similar reference numbers will be used throughout the drawings to refer to the same or similar parts.

In a system for an electronic commerce which includes a buyer's terminal providing an Internet service, a shopping mall server selling goods in the Internet, a payment server including a financial institution, and a transaction service server communicating with the said servers and terminal and operating the electronic commerce, a method for the electronic commerce comprising the steps of: downloading a data communication means in the buyer's terminal from the transaction service server when a buyer registers himself/herself as a member of the transaction service server; sending sales information from the shopping mall server to the buyer's terminal when the buyer sends a purchasing proposal to the shopping mall server using the buyer's terminal; presenting the buyer with a selection of the forms of payment when the buyer receives the sales information of the ordered products from the shopping mall server; sending purchase and payment information to the transaction service server through the buyer's terminal; requesting the payment server to approve a transaction; sending a transaction approval from the payment server to the transaction service server after checking the buyer's bank balance and validating the credit card and card limit; sending the transaction approval from the transaction service server to both the shopping mall server and the buyer; delivering goods from shopping mall server to the buyer; and asking the payment server to pay for the delivered goods and transferring the money from a temporary bank account of the transaction service server into the shopping mall server after the buyer sends a transaction confirmation to the transaction service server using the buyer's terminal.

FIG. 1 is a schematic representation of an electronic commerce system according to a first embodiment of the present invention. Referring to FIG. 1, a consumer-oriented electronic payment system consists of four parties, as follows:

1. A buyer's terminal 100: The buyer's terminal 100 in which a data communication means is installed provides shopping information and Internet communication to the buyer such that the buyer can buy the goods through an Internet or Word Wide Web.

2. A shopping mall server 200: The shopping mall server 200, which is product on-line seller and puts articles on sale on the Internet, provides various product information to the buyer's terminal 100.

3. A payment server 300: The payment server 300, e.g., a bank or a credit card company, provides buyer's credit information and financial information for on-line electronic commerce.

4. A transaction service server 400: The transaction service server 400 connected to the buyer's terminal 100, the shopping mall server 200 and the payment server 300. The transaction service server 400 receives purchasing information from the buyer's terminal 100 and request the payment server 300 to approve the transaction when the buyer purchases the products through the shopping mall server 200. Additionally, after the transaction service server 400 receives transaction approval information from the payment server 300, it sends the transaction approval information to the shopping mall server 200 and buyer. Thereafter, when the delivery and the transaction are complete, the transaction service server 400 receives transaction completion information from the data communication means installed in the buyer's terminal 100, and then asks the payment server 300 to pay for the products, thereby paying for the products to the shopping mall server 200. Accordingly, the transaction service server 400 acts as a go-between for the electronic commerce system.

Furthermore, the above-mentioned electronic payment system can include a certificate authority 500 that identifies the authentication and issues the certificates. The buyer can submit the certificate issued by the certificate authority 500.

The buyer's terminal 100 is the wire or wireless terminal supporting: the Internet communication. This terminal may be a computer or other means of accessing the Internet. The buyer's terminal 100 makes the users connect the transaction service server 400 and then register themselves as members. Therefore, the buyer can download the data communication means, such as software for the electronic commerce, in the buyer's terminal 100 as a user interface.

FIG. 2a is a block diagram showing functional configuration of the buyer's terminal. A transaction software installed in the buyer's terminal as a data communication means includes a product selecting section 110, a purchase information storage section 120, a payment selecting section 130, a purchase completion confirming section 140, and a communication section 150.

The product selecting section 110 helps the buyer to select the products that the buyer wants, and the purchase information storage section 120 stores the data of the buyer's purchase information. The payment selecting section 130 presents the buyer with a selection of the forms of payment, thereby doing the process of the transaction in accordance with the selected payment method. The purchase completion confirming section 140 sends the transaction completion information when the delivery was complete. Further, the communication section 150 provides data communications among the data communication equipments that are connected through the on-line.

The buyer's terminal 100, which includes the transaction software having above-mentioned sections, provides the product information of the shopping mall server 200 to the buffer who has access to the terminal through a membership authentication process. Furthermore, the buyer's terminal 100 stores data of buyer's information and a transaction information list, such as seller's name, seller's web page location (i.e., URL), seller's member-shop number, transaction number, transaction day, product name, price, amount or quantity, delivery information, delivery confirmation, etc. These data of the transaction information list can be supplied by the shopping mall server 200. The buyer's terminal 100 also helps the buyer to select the various purchasing method of the present invention, encodes the transaction information list or data of the ordered products, and then sends this cipher to the transaction service server 400. The buyer's terminal 100 checks the delivery of the goods that the buyer ordered, and sends to the transaction service server 400 the information about the transaction confirmation in cipher. At this time when the buyer's terminal send the purchasing information in cipher to the transaction service server 400, the buyer can input the payment information, such as account number, password or PIN (personal identification number), credit card number, etc. This payment information can previously be stored in the buyer's terminal 100 and then selectively send the information without typing the information. Due to the transaction software installed in the buyer's terminal 100, the buyers can voluntarily change their ID and password stored in the buyer's terminal 100, and thus, the other party including the system operator cannot know them. Further, the buyer's terminal keeps the security of the data by way of encoding/decoding the sent or received data.

The shopping mall server 200 is the server supporting an on-line shopping mall service. The shopping mall server 200 has an internal settlement system that is compatible with the consumer-oriented payment system. Thus, the buyer call selectively choose one of the payment systems that the shopping mall server 200 operates. The internal settlement system of the shopping mall server 200 can be provided by the transaction service server 400 in order to harmoniously conduct the present invention.

FIG. 2b is block diagram showing functional configurations of the shopping mall server 200. As shown in FIG. 2b, the shopping mall server 200 includes a product information transmitting section 210 that sends the product information to the buyer's server 100, a payment checking section 220 that validates the buyer's ability of paying for the ordered product after receiving the payment information from the transaction service server 400, and a product transmitting section 230 that sends the ordered products to the buyer. When the shopping mall server 200 receives the purchasing proposal from the buyer, the shopping mall server 200 sends to the buyer's terminal 100 the sales information, such as seller's name, seller's web page location (i.e., URL), seller's member-storage number, transaction number, product name, price, amount or quantity, etc.

The payment server 300 is a financial institution, such as a bank or a credit card company. The payment server 300 makes sure whether the buyer can afford to buy the products or not, and pays the shopping mall server 200 for the products the buyer bought after finishing the transactions.

FIG. 2c is block diagram showing functional configurations of the transaction service server 400. The transaction service server 400 provides a consumer-oriented payment system and operates the settlement system that enhances secure transaction. As shown in FIG. 2c, the transaction service server 400 includes a payment and purchase information storage section 410, a transaction approval inquiry section 420, a transaction approval information storage section 430, a temporary bank account 440, a product transmission information storage section 450, and a payment settling section 460. The payment and purchase information storage section 410 handles the payment and purchase information about the ordered product from the buyer's terminal 100, and the transaction approval inquiry section 420 requests the payment server 300 to approve the transaction in accordance with the purchasing proposal from the buyer's terminal 100. The transaction approval information storage section 430 stores the transaction approval information data transmitted from the payment server 300. The temporary bank account 440 momentarily keeps the money for the ordered product, which is transmitted from the payment server 300. The product transmission information storage section 450 stores the product transmission information transmitted from the shopping mall server 200, and the payment settling section 460 conducts the settlement after the transaction is complete.

The transaction service server 400 receives and stores the payment and purchase information transmitted from the buyer's terminal 100, and then asks the payment server 300 about the transaction approval. Thereafter, the transaction service server 400 receives a reply to the inquiry about transaction approval from the payment server 300, and then sends the transaction approval information to the shopping mall server 200 and buyer's terminal 100. Furthermore, after receiving the transaction confirmation information from the buyer, the payment settling section 460 of the transaction service server 400 asks the payment server 300 to pay for the products the buyer bought, or transmits the money kept in the temporary bank account 440 to the shopping mall server 200. Namely, the transaction service server 400 is in charge of operating all things of settlement systems, such as normal transaction process and canceling transaction process.

The basic configuration of the above-mentioned parties can be the same as the Internet server that provides a web-site on the Internet. Namely, as well known, the Internet server configuration consists of client/server model; a HTTP web server that provides the terminal (e.g., the buyer's terminal 100) with a file having web pages; a database system storing the data; and a database management system (DBMS) that can write and read the data. Further, an organ of credit evaluation can constitute the Internet server. The detailed explanation of the above-mentioned Internet server configuration is omitted because it is well known to a person having ordinary skill in this art. Furthermore, because each server 300 or 400 has the communication section basically, this communication section is omitted in FIGS. 2b and 2c.

The certificate authority 500 of FIG. 1 validates the membership of the buyer in order to prevent the buyer from refusing to buy the goods. Further, the certificate authority 500 authenticates the buyer's certificate. In the present invention, this certificate authority 500 is supplementary element.

FIG. 3 is a flowchart depicting an essential prerequisite to perform the first embodiment of the present invention.

In the electronic commerce system according to present invention as shown in FIG. 1, the business service agreement should be preceded among the servers. Namely, referring to FIG. 3, the shopping mall server 200, the payment server 300, the transaction service server 400 and the certificate authority 500 agree on a business service contract with each other in step “C1”. The business service agreement includes business process, payment process and method, service commitment fee, etc. The servers 200, 300 and 400 and the certificate authority 500 are connected to each other through the private network line or virtual private network with encryption protocol.

In step “C2”, the transaction service server 400 also makes a business service agreement with the shopping mall server 200 that want to participate in the electronic commerce, and the buyer accesses the transaction service server 400 via the buyer's terminal 100, thereby requesting the service.

In step “C3”, the transaction service server 400 receives the buyer's basic information, such as the buyer's name, the resident registration number, the buyer's address, etc. Further, the transaction service server 400 receives the certificate (issued from the certificate authority 500) from the buyer and then validates the certificate to entitle the buyer to the membership. Alternatively, the transaction service server 400 can independently identify the buyer and issue the certificate.

In step “C4”, the transaction service server 400 distributes management number to each buyer and makes the buyer download the transaction software in the buyer's terminal 100. In the above-mentioned system, the buyer should have a membership.

FIGS. 4a and 4b are flowcharts depicting the process of the electronic commerce system according to the present invention.

As shown in FIG. 4a, after the previous preparation depicted in FIG. 3, the buyer accesses the shopping mall server 200 through the buyer's terminal 100, in step “C10”. Thereafter, the buyer sends the purchasing proposal to the shopping mall server 200, in step “C11”.

If the buyer wants to pay using the consumer-oriented payment system (in step “C12”), the shopping mall server 200 transmits sales information to the buyer's terminal 100 (in step “C13”). The sales information includes a reference number, a web page location (i.e., URL), a shopping mall name, an amount of money, item, quantity, etc. If the buyer does not want to use the consumer-oriented payment system of the present invention, the transaction can be conducted using the conventional settlement system, in step “C12a”.

From the buyer's viewpoint, the sales information that the shopping mall server 200 sends to the buyer's terminal 100 is purchasing information. In step “C14”, the buyer sends to the transaction service server 400 this purchasing information as well as the payment information such as the account number, password, card number, etc. In the next step “C15”, the transaction service server 400 asks the payment server 300 for transaction approval, based on the purchase and payment information that the buyer sends.

After receiving the inquiry about the transaction approval, the payment server 300 verifies that the buyer can afford to pay for the goods, in step “C16”. Namely, the payment server 300 checks the buyer's bank balance and verifies the credit card and card limit.

In step “C17” of FIG. 4a, in the case that the buyer has a bank account, the payment server 300 transfers the money into the temporary bank account of the transaction service server 400. In the case that the buyer wants to pay with the credit card, the payment server 300 issues a transaction approval number and sends the transaction approval information to the transaction service server 400. Thereafter, the transaction service server 400 sends to the buyer's terminal 100 the transaction approval information after receiving it from the payment server 300, in step “C18”. At the same time, the transaction service server 400 also sends to the shopping mall server 200 the transaction approval information.

The shopping mall server 200 delivers the goods the buyer ordered after checking the transaction approval information, i.e., step “C19” of FIG. 4b. Then, the shopping mall server 200 sends the delivery information to the transaction service server 400, i.e., step “C20”, and the transaction service server 400 sends the delivery information to the buyer's terminal 100, i.e., step “C21”.

Thereafter, the buyer sends the transaction confirmation to the transaction service server 400 using the transaction software of the buyer's terminal 100 after checking the delivered goods, i.e., step “C22”. Furthermore, if the delivered goods are deteriorated or if the goods are not delivered up to a designated day, the buyer cancels the transaction, in step “C22”. Meanwhile, in the case when the computer games or music are downloaded without delivering the goods, the step “C22” can be omitted. Namely, the transaction confirmation, the step “C22”. can be omitted and then the buyer can pay for downloading the programs.

When the buyer wanted to pay using a bank account, the transaction service server 400 transfers the money from its temporary bank account into a bank account of the shopping mall server 200, in step “C23”. Furthermore, when the buyer wanted to pay with the credit card, the transaction service server 400 sends the credit card transaction information to the payment server 300, with the result that the payment server 300 pay the shopping mall server 200 for the credit card transaction (i.e., step “C23”).

In order to prevent that the buyer does not send the transaction confirmation to the transaction service server 400 even though the buyer received the goods, the transaction service server 400 pays the shopping mall server 200 for the goods unless the buyer sends the transaction confirmation or transaction cancellation by the designated day. Namely, the transaction service server 400 regards the non-reply no later than the designated time as the transaction confirmation. However, in order to awaken the buyer's attention, the transaction service server 400 sends a cautionary notice to the buyer's terminal 100 before the designated time comes.

Now, the transaction cancellation process is explained when the buyer wants to cancel the transaction due to the mis-delivery or the defective product. As shown in FIG. 4b, the buyer sends the cancellation information to the transaction service server 400 and shopping mall server 200, i.e., steps “C30”. Thereafter, the buyer returns the delivered goods to the transaction service server 400, in step “C31”. At this time, the buyer advisably encloses the reason of cancellation. The return of the goods is performed by the previously determined contract. Namely, the buyer can deliver the goods to the transaction service server 400, or the transaction service server 400 can gather the goods by itself. For more convenience in returning the goods, the buyer encloses the shopping mall's web page location (i.e., URL), the transaction number, the buyer's management number, the buyer's registration number, etc.

After the delivered goods are returned, the transaction service server 400 sends the cancellation information about the transaction approval to the payment server 300 when the buyer wanted to pay with credit card, i.e., step “C32”. Alternatively, the transaction service server 400 refunds the money into the buyer's account when the buyer has the bank account, i.e., step “C32”. In step “C33”, the transaction service server 400 can send the returned goods to the shopping mall server 200, or sell the returned goods through the on-line auction site. The on-line auction can be conducted over the specialized Internet auction site, or the transaction service server 400 can open and operate its own auction site. When the transaction service server 400 sold the returned goods, the transaction service server 400 receives a commission of a certain percent on the sale of returned goods, and then transfers the residual money to the shopping mall server 200, i.e., step “C34”.

FIG. 5 is a flowchart depicting the steps of FIG. 1 performed when the buyers cancel the transactions due to the non-delivery of the ordered products. As shown in FIG. 5, the buyer's terminal 100 sends the cancellation information to the transaction service server 400 and shopping mall server 200 (i.e., step “C40”). The shopping mall server 200 requests the transaction service server 400 to cancel the transaction after checking the delivery, in step “C41”. When the buyer wanted to pay with the credit card, the transaction service server 400 requests the payment server 300 to cancel the credit-card transaction approval (i.e., step “C42”), complying with the cancellation requests. Alternatively, when the buyer used the bank account, the transaction service server 400 refunds the money into the buyer's bank account, in step “C42”. In order to prevent the shopping mall server 200 from denying receiving the cancellation information from the buyer, the transaction service server 400 requests the payment server 300 to cancel the credit-card transaction approval or refunds the money into the buyer's account unless the shopping mall server 200 requests the transaction cancellation or the deadline extension by the prearranged time. Thereafter, the transaction service server 400 send a final result of the canceling the transaction to the buyer's terminal, in step “C43”. Further, the transaction service server 400 stores the returned goods list in a customer information database, corresponding to each buyer. The transaction service server 400 also provides this information to the shopping mall server 200. Thus, the shopping mall server 200 can control and care for the depraved or delinquent buyers.

FIG. 6 is a flowchart depicting a second embodiment of the present invention performed when the transaction service server and the shopping mall server are plural. In the marketplace, it is ideal that a transaction service server is alone, but there are a lot of transaction service servers in practice. When the transaction service servers are plural, the transaction service servers make business agreements with each other since each transaction service server hardly make a contract with all shopping mall servers in the market.

In step “C50” of FIG. 6, a buyer who is a member of a first transaction service server 700 sends a purchasing proposal to a shopping mall server 600 that is a member of a second shopping mall server 800, and offers to want to pay using a consumer-oriented payment system through a buyer's terminal 100. The shopping mall server 600 sends sales information to the buyer's terminal 100, i.e., step “C51”. Thereafter, the buyer sends the purchasing information and payment information to the first transaction service server 700 using the buyer's terminal 100, in step “C52”.

After receiving the purchasing and payment information from the buyer, the first transaction service server 700 asks the payment server 300 for transaction approval, i.e., step “C53”. The payment server 300 verifies that the buyer can afford to pay for the goods after receiving the inquiry about the transaction approval from the first transaction service server 700. Namely, the payment server 300 checks the buyer's bank balance and validates the credit card and card limit.

In step “C54” of FIG. 6, if the buyer has a bank account, the payment server 300 transfers the money into a temporary bank account of the first transaction service server 700. If the buyer wanted to pay with the credit card, the payment server 300 issues a transaction approval number and sends the transaction approval information to the first transaction service server 700.

Thereafter, the first transaction service server 700 sends transaction approval information to the buyer's terminal 100 and to the second transaction service server 800 at the same time, i.e., respectively steps “C55” and “C55a”. The second transaction service server 800 sends the transaction approval information to the shopping mall server 600 after receiving this transaction approval from the first transaction service server 700, in step “C56”.

The shopping mall server 600 then delivers the goods the buyer ordered after checking the transaction approval information, i.e., step “C57”. Thereafter, the buyer sends the transaction confirmation to the first transaction service server 700 using the buyer's terminal 100 after checking the delivered goods, i.e., step “C58”. Then, the first transaction service server 700 requests the payment server 300 to pay for the goods the buyer bought, in step “C59”. Further, the first transaction service server 700 asks the second transaction service server 800 to pay the shopping mall server 600 for the goods the buyer bought, in step “C60”.

After receiving the request of payment from the first transaction service server 700, the second transaction service server 800 pays the shopping mall server 600 for the goods, in step “C61”. Between the first and second transaction service servers 700 and 800, they settle accounts after deducting the commission according to their contract, i.e., step “C 62”.

It will be apparent to those skilled in the art that various modifications and variation can be made in the system and method for the electronic commerce without departing from the spirit or scope of the present invention. Thus, it is intended that the present invention cover the modifications and variations of this invention provided they come within the scope of the appended claims and their equivalents.

### INDUSTRIAL APPLICABILITY

As mentioned before, the system and method for the electronic commerce have the following advantages.

Whenever the shopping mall correctly delivers the goods to the buyer, the shopping mall can get the secure payment. Since the buyer pays for the goods after checking the delivered goods, the transaction between the buyer and the seller is safe, thereby eliminating the distrust in the electronic commerce marketplace. Furthermore, the buyer can purchase something in any shopping mall site even thought that is unreliable or small because the buyer does not have to send the payment information to the shopping mall, thereby activating the electronic commerce transaction.

Additionally, accidental spreading to the personal information is prevented because the buyers do not have to send to the shopping mall the payment information, such as account number, password or PIN, credit card number, etc. When the buyer can use the a lot of shopping malls, the buyer do not have to input and send the payment information to each shopping mall, thereby increasing the number of the available shopping mall and also activating the electronic commerce market.

Since the buyer uses the transaction software installed in the buyer's terminal, the buyer does not have to input the information each time to purchase the goods. Further, the buyer does not have to access the transaction service server every time to receive the transaction information because the automatic service is provided by the transaction service server. Accordingly, the convenience of the buyer increases.

Additionally, when the buyer returned the dissatisfied goods, the transaction service server controls these returned goods. Namely, the transaction service server puts them on sale in the auction site or sends them to the shopping mall, thereby treating the returned goods appropriately and increasing the efficiency.

1. A system for an electronic commerce, comprising:
(1) a buyer's terminal that is used for purchasing goods through on-line service and that provides data communication and an Internet communication, comprising;
a product selecting section helping the buyer to select the products that the buyer wants;
a purchase information storage section storing data of the buyer's purchase information;
a payment selecting section presenting the buyer with a selection of the forms of payment, thereby doing the process of the transaction in accordance with the selected payment method;
a purchase completion confirming section sending the transaction completion information when the delivery is complete; and
a communication section providing data communications among data communication equipments that are connected through the on-line;
(2) a shopping mall server providing various product information to the buyer's terminal so as to sell the goods on the Internet, comprising;
a product information transmitting section 210 sending product information to the buyer's server;
a payment checking section validating the buyer's ability of paying for the ordered product; and
a product transmitting section sending the ordered products to the buyer;
(3) a payment server providing buyer's credit information and financial information for on-line electronic commerce, the payment server approving the transaction and conducting the settlement; and
(4) a transaction service server connected to the buyer's terminal, the shopping mall server and the payment server, the transaction service server requesting the payment server to approve the transaction after receiving purchasing information from the buyer's terminal. sending the transaction approval information to the shopping mall server and buyer after receiving the transaction approval information from the payment server, and paying for the products to the shopping mall server so as to acting as a go-between for the electronic commerce system when the delivery and the transaction are complete and when the transaction service server receives transaction completion information from the buyer's terminal, the transaction service server comprising;
a payment and purchase information storage section handling the payment and purchase information about the ordered product from the buyer's terminal;
a transaction approval inquiry section requesting the payment server to approve the transaction in accordance with the purchasing proposal from the buyer's terminal;
a transaction approval information storage section storing the transaction approval information data transmitted from the payment server;
a temporary bank account momentarily keeping the money for the ordered product, which is transmitted from the payment server;
a product transmission information storage section storing the product transmission information transmitted from the shopping mall server; and
a payment settling section conducting the settlement after the transaction is complete.

2. The system of claim 1, wherein the transaction service server provides the shopping mall server with the payment information including bank account, password and credit card number.

3. In a system for an electronic commerce which includes a buyer's terminal providing an Internet service, a shopping mall server selling goods in the Internet, a payment server including a financial institution, and a transaction service server communicating with the said servers and terminal and operating the electronic commerce, a method for the electronic commerce comprising the steps of:
downloading a data communication means in the buyer's terminal from the transaction service server when a buyer registers himself/herself as a member of the transaction service server;
sending sales information from the shopping mall server to the buyer's terminal when the buyer sends a purchasing proposal to the shopping mall server using the buyer's terminal;
presenting the buyer with a selection of the forms of payment when the buyer receives the sales information of the ordered products from the shopping mall server;
sending purchase and payment information to the transaction service server through the buyer's terminal;
requesting the payment server to approve a transaction;
sending a transaction approval from the payment server to the transaction service server after checking the buyer's bank balance and validating the credit card and card limit;
sending the transaction approval from the transaction service server to both the shopping mall server and the buyer;
delivering goods from shopping mall server to the buyer; and
asking the payment server to pay for the delivered goods and transferring the money from a temporary bank account of the transaction service server into the shopping mall server after the buyer sends a transaction confirmation to the transaction service server using the buyer's terminal.

4. The method of claim 3, wherein the payment server checks a buyer's balance when the buyer uses a bank account to pay for the goods and transfer the money into a temporary bank account of the transaction service server, and issues a transaction approval number when the buyer uses the credit card to pay for the goods, whereas the transaction service server transfers the money from the temporary bank account thereof into the shopping mall server after checking a transaction completion information transmitted from the buyer's terminal when the buyer uses the bank account to pay for the goods, and sends credit card transaction information to the payment server to pay the shopping mall server for the credit card transaction when the buyer uses the credit card.

5. The method of claim 3, further comprising the step of:
sending cancellation information to both the transaction service server and the shopping mall server using the buyer's terminal when the buyer cancels a transaction, and then returning the goods to the transaction service server;
sending cancellation information about the transaction approval from the transaction service server to the payment server when the buyer uses the credit card to pay for the goods, or refunding the payment into a buyer's bank account when the buyer uses a bank account to pay for the goods;
sending the retturned goods to the shopping mall by the transaction service server, or selling the returned goods at auction by the transaction service server; and
giving the amount of money obtained for the returned goods by auction.
